(19) United States
(12) Patent Application Publication
(10) Pub. No.: US 2003/0173715 A1
(43) Pub. Date: Sep. 18, 2003

(54) Resistive-heated composite structural members and methods and apparatus for making the same

(76) Inventors: James T. Grutta, Salt Lake City, UT (US); Larry E. Stanley, Bountiful, UT (US); Jay Batten, Birch Run, MI (US)

Correspondence Address: Edmund P. Anderson, Esq., Delphi Technologies, Inc. M/C 480.414.420, 1450 West Long Lake, 4th Floor, Troy, MI, 48098, US

(21) Appl. No.: 10/099,823

(22) Filed: Mar. 13, 2002

(51) Int. Cl. H05B 3/00

(52) U.S. Cl. 264/450; 425/130; 425/406

(57) ABSTRACT

Composite structural members, methods, and apparatus for making the same are described. The composite members are formed by resistive heating of the composite material using an electric current with sufficient voltage through the composite. The resistance of the composite material creates an energy loss in the form of heat, melting the matrix of the composite material and allowing the composite material to be shaped in any desired manner.

### STATEMENT REGARDING FEDERALLY SPONSORED RESEARCH AND DEVELOPMENT

The U.S. Government may have certain rights in this invention pursuant to Contract No. 329515-AMB.

### FIELD OF THE INVENTION

The present invention relates to composite structural members and methods and apparatus for making the same. In particular, the present invention relates to resistive-heated composite structural members and methods and apparatus for making the same.

### BACKGROUND OF THE INVENTION

In recent years there has been an increasing emphasis on the use of lightweight composite materials. One application, for example, has been their use to improve the efficiency of motor vehicles. To that end, the United States Government and the U.S. Council for Automotive Research (USCAR)—which represents Daimler Chrysler, Ford, and General Motors have partnered to form the Partnership for a New Generation of Vehicles (PNGV). One goal of PNGV is to develop technology, such as composite technology, that can be used to create environmentally friendly vehicles with up to triple the fuel efficiency, while providing today's affordability, performance and safety. For example, PNGV wants to improve the fuel efficiency of today's vehicles from about 28 miles per gallon (mpg) to about 83 mpg and a 40-60% decrease in the present curb weight (3200 pounds).

Composites are a mixture or combination, on a macro scale, of two or more materials that are solid in the finished state, are mutually insoluble, and differ in chemical nature. There exist numerous known methods to make composite structural members. One commonl used in the art makes a composite member by heating a thermoplastic-based composite material so that the thermosplastic polymer matrix is melted. Once melted, the thermoplastic-based composite material is then molded to obtain the desired shape of the structural member.

Such thermoplastic composite materials are often heated in two ways. First, they are heated by thermal conduction from a metal tool. This is typically used in compression molding methods. This first type of heating—by conduction—requires sufficient energy and time to heat both the tool and the composite material. Energy in the tool is mostly wasted as it is not used to heat the composite material and dissipates primarily into the ambient atmosphere.

The second type of heating uses infrared light. This method is typically used in thermoforming methods. This method requires the layers of the composite to be first consolidated into a flat plate so the heat may transfer into the composite laminate. The pre-consolidation stage, however, reduces the ability of the composite material to be draped into a deeply drawn shape.

### SUMMARY OF THE INVENTION

The invention provides composite structural members and methods and apparatus for making the same. The composite members are formed by resistive heating of the composite material using an electric current with sufficient voltage through the length of the fibers. The resistance of the composite material creates an energy loss in the form of heat, melting the matrix of the composite material and allowing the composite material to be shaped in any desired manner.

### BRIEF DESCRIPTION OF THE DRAWINGS

FIGS. 1-3 are views of composite structural members and methods and apparatus of making the same according to the invention, in which:

FIG. 1 depicts stacked plies used in one aspect of making the composite structural member according to the invention;

FIG. 2 one aspect of a process for making the composite structural member according to the invention; and

FIG. 3 illustrates another aspect of a process for making the composite structural member according to the invention.

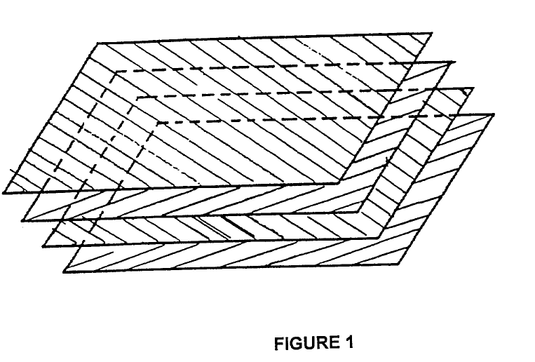

FIGS. 1-3 presented in conjunction with this description are views of only particular—rather than complete—portions of the composite structural members and methods and apparatus of making the same.

### DETAILED DESCRIPTION OF THE INVENTION

The following description provides specific details in order to provide a thorough understanding of the present invention. The skilled artisan, however, will understand that the present invention can be practiced without employing these specific details. Indeed, the present invention can be practiced by modifying the illustrated structural member and method and can be used in conjunction with apparatus and techniques conventionally used in the composite industry.

The composite structural members of the invention can have any shape or combination of shapes that can be formed by the process and apparatus described below. For example, the composite structural members can have a tubular or non-tubular shape, a complex shape, a contoured shape, a bent or straight shape, or a combination of shapes.

The structural members of the invention can be formed from any composite materials known in the art. In one aspect of the invention, the materials for the structural members comprise any suitable reinforced resin matrix material (RRMM), which is a resin matrix material (RMM) with continuous or discontinuous reinforcement material embedded in the resin matrix. In one aspect of the invention, the RMM is an organic resin matrix material (ORMM). See, for example, U.S. Pat. No. 5,725,920 and 5,309,620, the disclosures of which are incorporated herein by reference.

In one aspect of the invention, the ORMM can be a thermoplastic resin matrix material. Thermoplastic resins are polymeric materials that do not set irreversibly when heated, e.g., they soften when exposed to heat and then return to their original condition when cooled. Examples of thermoplastic resins include polypropylene, polyethelene, polyamides (nylons), polyesters (PET, PBT), polyether ketone (PEK), polyether ether ketone (PEEK), polyphenylene sulfide (PPS), polyphenylene oxide (PPO) and its alloys, and polyvinyl resins, or combinations thereof. The thermoplastic resins can contain various additives as known in the art, such as cross-linking agents, curing agents, fillers, binders, or ultraviolet inhibitors. Preferably, polyamides (nylons), polyester, PEEK, polycarbonate, and polypropylene resins, or combinations thereof, are employed as the thermoplastic resin in the invention.

The material used to reinforce the RMM of the present invention can be in any form that reinforces the resin matrix. Examples of reinforcement forms include unidirectional tape, multidirectional braids, woven and nonwoven fabrics, random mats (both continuous and discontinuous strand), hand laid or stitched preforms, fibers, filaments, or whiskers, and combinations thereof. The type of material used to reinforce the RMM can be any type serving such a reinforcing function. Preferably, the form of the reinforcement materials for the resin matrix is a fiberous material, such as continuous or discontinuous fibers. Examples of fibers that can be employed in the invention include, but are not specific to, S-Glass, E-Glass, aramid, graphite, carbon, ultra-high molecular weight polyethylene, boron, silicon carbide, ceramic, quartz, metals, isotropic metals (aluminum, magnesium and titanium), metal coated organic fibers, CAMP, hybrids of these fibers, or combinations of these fibers. See, for example, U.S. Pat. No. 6,117,534, the disclosure of which is incorporated herein by reference.

In yet another aspect of the invention, non- or partially-cured composite materials are used as the material for the structural members. Any composites known in the art such as laminar, particle, fiber, flake, and filled composites can be employed in the invention. The non- or partially-cured composite materials can be an ORMM (thermoplastic resin) reinforced with a continuous fiber or thermoset materials.

Preferable composite materials used in the invention include thermoplastic composite materials (i.e., thermoplastic prepregs) typically in the form of sheets or laminates (or plies), which can be formed by impregnating a plurality of fiber reinforcement tows with a thermoplastic polymer. Methods of making thermoplastic prepreg sheets and the sheets themselves are well known. See, for example, those sheets described in U.S. Pat. No. 4,495,017, the disclosure of which is incorporated herein by reference. Preferable reinforcement (fibers) for such thermoplastic composites include aramids, glass materials, nickel carbide, silicone carbide, ceramic, carbons and ultra-high molecular weight polyethylene, or a combination thereof. See, for example, U.S. Pat. Nos. 4,968,545, 5,102,723, 5,499,661, 5,579,609, and 5,725,920, the disclosures of which are incorporated herein by reference. Carbon, glass, metals and especially isotropic metals like aluminum, magnesium and titanium, metal-coated organic fibers, and aramid fibers, or a combination thereof, can also be employed as the fibers. See, for example, U.S. Pat. Nos. 5,601,892 and 5,624,115, the disclosures of which are incorporated herein by reference. Even more preferably, electrically conductive (either wholly or partially) fibers are employed in the invention.

The fiber volume in the thermoplastic prepregs may be varied so as to maximize the mechanical, electrical, and thermal properties of the composite member. See, for example, U.S. Pat. No. 5,848,767, the disclosure of which is incorporated herein by reference. High fiber volume parts are stiffer and, in the case of thermally conductive fibers, the parts are more thermally conductive. With the exceptions described below, the fibers of the prepregs may be oriented within the prepreg material in any desired direction as known in the art, such as about 0 to about 90 degrees, including equal numbers of fibers balanced in opposing directions. See, for example, U.S. Pat. No. 4,946,721, the disclosure of which is incorporated herein by reference.

In one aspect of the invention, the composite structural members contain at least one layer of such ORMM materials. One layer is sufficient to form the member and provide the desired structural characteristics for the structural member. Additional layers can be added to improve the strength, stiffniss, or other physical characteristics of the structural member. It is possible to use a single layer with fibers having complementary orientations. With the exceptions noted below, however, it is preferred to use a plurality of layers with complementary orientations to balance intrinsic stresses in the layers that make up the sections that result when, as described below, the thermoplastic materials are fully cured. To be complementary, the fibers in successive layers should be symmetric and balanced (e.g., by having the fibers offset from the sheet axis by equal and opposite amounts from one layer to another) as shown in FIG. 1. The fibers can also be oriented to meet the design parameters of the component into which they are being incorporated, e.g., to optimize the structural strength against the expected load. The fibers could be oriented at any suitable angle, including at angles ranging from about 0 to about 90 degrees, including in ±15, ±30, ±45, ±60, and ±75 degrees, or as otherwise known in the art. See, for example, U.S. Pat. Nos. Re. 35,081 and 5,061,583, the disclosures of which are incorporated herein by reference.

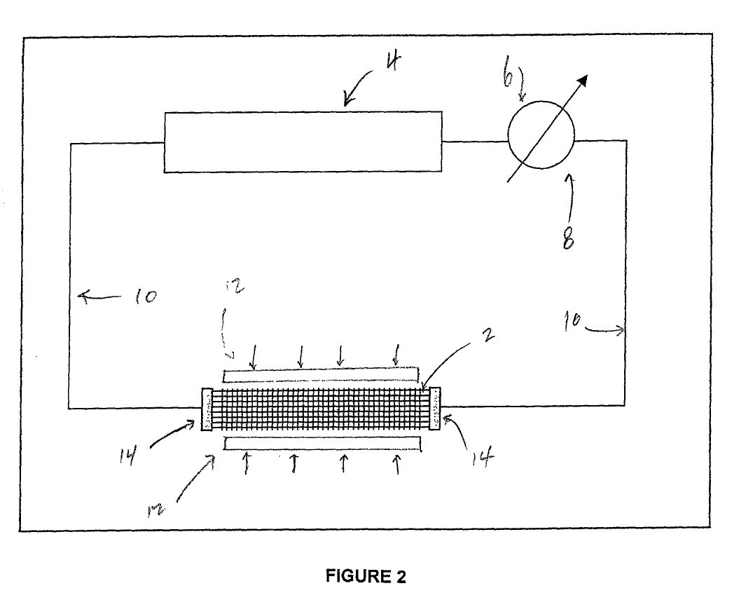

The structural member of the invention can be made by any suitable process known in the art that provides the desired structure. In one aspect of the invention, the composite members are made by the process and apparatus exemplified in FIG. 2, referred to as the resistive heating (RH) process. In this aspect of the invention, a composite preform 2 is first created. The composite preform, which has a precursor structure, has substantially the same amount of composite material as desired for the final structural member, but the shape of the precursor structure can be modified by the process to take a different shape.

In one aspect of the invention, the composite preform is made by stacking a plurality of composite plies as described above. During the stacking process, the plies are generally cut and/or patterned to the desired size before being stacked. After being stacked, in one aspect of the invention, air is removed by hand or by using a suitable device (such as a roller). In another aspect of the invention, the stacks of plies are ultrasonically tack welded together at locations dictated by the design, allowing them to be moved or handled without disturbing the preform.

Although not preferred, a bonding agent can be placed between successive layers of the composite plies. The bonding agent can be placed on selected areas only, or in a pattern such as in rows and/or columns, or over entire sections of the plies. Any suitable agent which helps bond the plies and is compatible with all of the processes employed to make the structural member can be employed, including glues, curing agents, adhesive materials, or a combination thereof. See, for example, U.S. Pat. No. 5,635,306, the disclosure of which is incorporated herein by reference. The bonding agent can be applied by hand or mechanical apparatus prior to or during the stacking process.

Next, the composite preform (with a precursor structure) is electrically connected to a power supply means 4 (as well as other components) to form an electrical circuit. The composite preform is electrically connected to the power supply via suitable connection means 14. The connection means also operates to secure the preform. Any suitable connection means known in the art operates in this manner can be employed in the invention, such as copper, silver, or any other conductive metals. Copper is preferably employed as the connection means in one aspect of the invention.

The power supply means 4 is used in the invention to provide the necessary power. In one aspect of the invention, the power supply means provides an AC or DC voltage sufficient to carry out the process described below, such a voltage ranging from about 2 to about 250 volts. Any power supply means that operates in this manner can be employed in the invention, including any regulated AC or DC power supply, or a battery.

Within the electrical circuit, a voltage controller 6 is provided. The voltage controller regulates the voltage supplied to the connection means and, therefore, the voltage supplied to the composite preform. Any voltage controller known in the art can be employed in the invention, such as analog or digital voltage controllers.

As well, the electrical circuit contains a current controller 8. The current controller can be separate from—or combined with—the voltage controller. In one aspect of the invention, as illustrated in FIG. 2, the current controller is combined with the voltage controller. The current controller regulates the current supplied to the connection means and, therefore, the current supplied to the composite preform. Any current controller known in the art can be employed in the invention, such as analog or digital current controllers.

The remainder of the electrical circuit comprises means for conducting the power 10 (voltage) from the power supply. Any suitable conducting means 10 known in the art that can conduct the desired voltage without degrading can be used in the invention. Examples of such conducting means that can be used in the invention include metal wires sufficient to carry the power range.

After being connected to the electrical circuit as shown in FIG. 2, compressing means 12 are provided around the composite preform. The compressing means provide a compressive pressure to the preform, changing its shape as described below. The compressing means are also not electrically conductive. Any suitable compressing means known in the art can be used in the invention, such as a bladder, matched tooling, or other molding apparatus. In one aspect of the invention, a matched mold made of ceramic is used in the invention. The mold comes in two or more pieces that fit together to contain the composite preform. The inner surface of the mold has the desired shape that will be imparted to the outer surface of the composite material during the process.

After providing the compressing means, the power supply is adjusted to supply sufficient voltage and current to the composite preform. The current/voltage flows across the composite preform from the region of higher potential to the region of lower potential. As the current/voltage flows across the composite preform, heat is created due to the resistance of the composite material.

Heat is created in the composite preform as electrical energy is transformed into thermal energy because of the resistance of the composite. The amount of heat generated depends on the voltage across the composite preform, the resistance of the composite preform (which depends on the type of composite material), the orientation of the fibers, and the fiber volume fraction. The heat generated raises the temperature of the composite preform.

The current/voltage across the composite is carefully regulated until the heat generated raises the temperature of the preform to the melting point of the thermosplastic polymer matrix of the composite material. The rate at which this melting point is obtained depends on the amount of current and voltage applied across the composite preform, as well as the type of composite material. Thus, for any given type of composite material, the current and voltage are controlled to obtain the desired amount of heat in the desired amount of time. For example, when carbon/nylon-6 is employed as the composite material, the voltage can range from about 2 to about 250 volts, and is preferably about 24 volts and the current can range from about 10 mA to about 100 amperes, and is preferably about 3.5 amperes. The current and voltage applied to the preform must also be controlled as the heating continues. As the heating continues, the resistance of the composite material in the preform lowers due to consolidation of the composite material.

Preferably, the current/voltage should flow through every portion of the composite preform, thereby generating heat in—and thereby melting—every portion of the composite material. In one aspect of the invention, obtaining this result can be optimized by making the fiber orientation near the connection means unidirectional, e.g., substantially parallel to the flow of the electrical current. By making all fibers with the same orientation in these areas, the voltage is able to flow further into the bulk of the composite preform with less resistance than if the fibers were not unidirectional.

Once the desired temperature is reached, the voltage is the regulated to maintain the temperature at that level, e.g., within about 5 degrees Celsius. The compressing means then applies a pressure of about 0.7 MPa to about 4.1 MPa to the composite preform. The voltage and pressure are applied for a time sufficient to consolidate the components (i.e., plies) of the composite preform. Generally, the time necessary for this consolidation process can range from about 1 seconds to about 3 minutes.

Then, the voltage is turned off and the composite material allowed to cool. Optionally, the consolidated composite member can be cooled by additional cooling means, such as a cooling fluid like air or water. When the desired temperature is reached, the pressure is released. The compressing means and the connection means are removed and the final composite structural member is removed. Through the processes described above, the plies are permanently physically bonded to the adjacent plie(s).

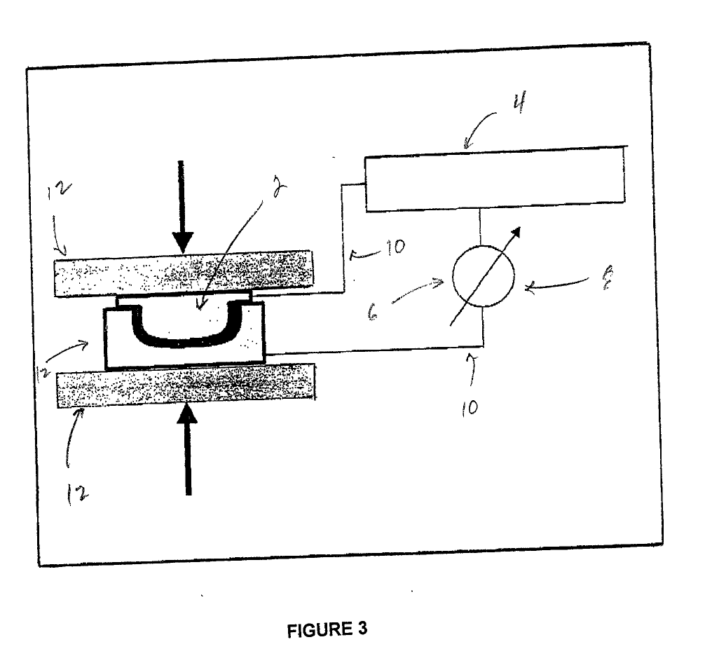

In an alternative aspect of the invention, the composite structural members of the invention are made using a similar—but slightly different—process and apparatus (referred to as the improved resistive heating (IRH) process). In this aspect of the invention, as illustrated in FIG. 3, the power supply 4, voltage controller 6, current controller 8, conducting means 10, and compressing means 12 are provided as detailed above. In this other aspect of the invention, however, the electrical connection means are eliminated. Rather, the electrical connection is made directly to the composite preform and the compressing means 12.

As depicted in FIG. 3, the composite preform 2 is located within compressing means 12, e.g., the mold. In this alternative aspect of the invention, the current flows from the power supply, through the voltage controller, through the compressing means (mold), and then through the composite preform. Thus, the compressing means acts as the electrical connections means to the composite preform in this aspect of the invention. Accordingly, the compressing means must be made of a material that is both electrically conductive, yet is able to withstand the operating pressures and temperatures, such as metal or composite materials. Thus, in this alternative aspect of the invention, the composite material in the preform need not extend beyond the connection means because there is no need to contact the electrical connection means (as in RH process described above).

The electrical circuit is completed in this aspect of the invention by connecting the composite preform directly to the conducting means. Thus, current flowing from the compressing means will flow directly through the composite preform. As described above, the composite preform resists the flow of the electrical current, creating the energy loss in the form of heat.

In this alternative aspect of the invention, the carbon fibers need not be oriented carefully (as in the RH process described above). This careful orientation was necessary to insure that the voltage penetrated into the bulk of the material in the composite preform. In this alternative aspect of the invention, however, a portion of the compressing means also operates as the electrical connection means to provide current/voltage to the composite preform. As the compressing means contacts a large portion of the composite preform, the voltage flows through a large portion of the preform. Thus, it becomes unnecessary to orient the fibers to insure the penetrating voltage.

In this alternative aspect of the invention, the current and voltage is also regulated. For any given type of composite material, as well as the given type of material used for the compressing means, the voltage is carefully controlled to obtain the desired amount of heat in the desired amount of time. For example, when carbon/nylon-6 is employed as the composite material and steel/ceramic is employed as material for the compressing means, the voltage can range from about 2 to about 250 volts, and is preferably about 24 volts, while the current can range from about 10 mA to about 100 amperes, and is preferably about 3.5 amperes.

Once formed by either of the processes of the invention, the structural members of the invention can be modified or cut for any desired use. Numerous shapes and configurations can be made by cutting along any dimension of the structural members. Further modifications—other than just cutting—can be made to the structural members of the invention. For example, channels, holes, patterns, and similar modifications can be made in the structural member for many reasons, such as to attach a structural component, modify the surface properties, or a similar purpose. Any structural component known in the art can be added to the structural member, such as a bracket, fastener, coupler, cap, or the like.

The structural member of the invention has numerous uses such as a tie, torsion-bar, tube, beam, column, cylinder and the like and can be used in numerous industries.

The structural member of the present invention can be used in the automotive, transportation, aerospace, and defense industries in applications such as airplane components, vehicle components such as tracks, trains, shipping containers, defense-related applications, recreational applications such as bikes, sail masts, shafts for golf clubs and racquets, or commercial applications such as bridges and buildings.

Having described the preferred embodiments of the present invention, it is understood that the invention defined by the appended claims is not to be limited by particular details set forth in the above description, as many apparent variations thereof are possible without departing from the spirit or scope thereof.

We claim:

1. A process for making a composite structural member, comprising:
providing a preform of a composite material with a reinforcement material in a polymer matrix;
flowing an electrical current with a voltage across the preform to substantially melt the polymer matrix; and
cooling the composite material to form a composite structural member.

2. The process of claim 1, wherein the reinforcement material comprises electrically-conductive fibers.

3. The process of claim 1, wherein the polymer matrix comprises a thermoplastic polymer.

4. The process of claim 1, including regulating the current and the voltage.

5. The process of claim 4, including maintaining the voltage within the range of about 2 to about 250 Volts

6. The process of claim 4, including maintaining the current within the range of about 10 microamperes to about 100 amperes.

7. The process of claim 1, including maintaining the current and voltage for about 1 second to about 3 minutes.

8. The method of claim 1, further including compressing the composite material while flowing the electrical current and while cooling.

9. A process for making a composite structural member, comprising:
providing a preform of a composite material comprising conductive fibers in a thermoplastic polymer matrix;
flowing an electrical current with a voltage across the preform to substantially melt the polymer matrix; and
cooling the composite material to form a composite structural member.

10. A process for making a composite structural member, comprising:
providing a preform of a composite material comprising conductive fibers in a thermoplastic polymer matrix;
flowing an electrical current of about 10 microamperes to about 100 amperes with a voltage of about 2 to about 250 volts across the preform to substantially melt the polymer matrix; and
cooling the composite material to form a composite structural member.

11. A composite structural member made by the method comprising:
providing a preform of a composite material with a reinforcement material in a polymer matrix;
flowing an electrical current with a voltage across the preform to substantially melt the polymer matrix; and
cooling the composite material to form a composite structural member.

12. A composite structural member made by the method comprising:
providing a preform of a composite material comprising conductive fibers in a thermoplastic polymer matrix;
flowing an electrical current with a voltage across the preform to substantially melt the polymer matrix; and
cooling the composite material to form a composite structural member.

13. A composite structural member made by the method comprising:
providing a preform of a composite material comprising conductive fibers in a thermoplastic polymer matrix;
flowing an electrical current of about 10 microamperes to about 100 amperes with a voltage of about 2 to about 250 volts across the preform to substantially melt the polymer matrix; and
cooling the composite material to form a composite structural member.

14. A process for heating a composite material, comprising:
providing a preform of a composite material with a reinforcement material in a polymer matrix; and
flowing an electrical current with a voltage across the preform to substantially melt the polymer matrix.

15. The process of claim 14, wherein the reinforcement material comprises electrically-conductive fibers.

16. The process of claim 14, wherein the polymer matrix comprises a thermoplastic polymer.

17. The process of claim 14, including regulating the current and the voltage.

18. The process of claim 17, including maintaining the voltage within the range of about 2 to about 250 volts.

19. The process of claim 17, including maintaining the current within the range of about 10 microampers to about 100 amperes.

20. The process of claim 14, including maintaining the current and voltage for about 1 second to about 3 minutes.

21. The method of claim 14, further including compressing the composite material while flowing the electrical current.

22. A process for heating a composite material, comprising:
providing a preform of a composite material comprising conductive fibers in a thermoplastic polymer matrix; and
flowing an electrical current with a voltage across the preform to substantially melt the polymer matrix.

23. A process for heating a composite material, comprising:
providing a preform of a composite material comprising conductive fibers in a thermoplastic polymer matrix; and
flowing an electrical current of about 10 microamperes to about 100 amperes with a voltage of about 2 to about 250 volts across the preform to substantially melt the polymer matrix.

24. A composite structure made by the method comprising:
providing a preform of a composite material with a reinforcement material in a polymer matrix; and
flowing an electrical current with a voltage across the preform to substantially melt the polymer matrix.

25. A composite structure made by the method comprising:
providing a preform of a composite material comprising conductive fibers in a thermoplastic polymer matrix; and
flowing an electrical current with a voltage across the preform to substantially melt the polymer matrix.

26. A composite structure made by the method comprising:
providing a preform of a composite material comprising conductive fibers in a thermoplastic polymer matrix; and
flowing an electrical current of about 10 microamperes to about 100 amperes with a voltage of about 2 to about 250 volts across the preform to substantially melt the polymer matrix.

27. An apparatus for heating a composite structure, comprising
means for supply an electrical current with a voltage;
means for controlling the electrical current;
means for controlling the voltage; and
means for flowing the current across a composite structure.

28. The apparatus of claim 27, wherein the supplying means comprises a battery.

29. The apparatus of claim 27, wherein the current controlling means comprises an analog or digital current controller.

30. The apparatus of claim 27, wherein the voltage controlling means comprises an analog or digital voltage controller.

31. The apparatus of claim 27, wherein the current controlling means and the voltage controlling means are combined in a single device.

32. The apparatus of claim 27, wherein the flowing means includes an electrical conducting means and an electrical connecting means.

33. The apparatus of claim 32, wherein the electrical conducting means comprises electrical wiring.

34. A system for making a composite structure, comprising:
an apparatus for heating a composite material, comprising means for supply an electrical current with a voltage, means for controlling the electrical current, means for controlling the voltage, and means for flowing the current across a composite structure; and
means for compressing the composite material.
